(19) United States
(12) Patent Application Publication
(10) Pub. No.: US 2017/0177178 A1
(43) Pub. Date: Jun. 22, 2017

(54) E-READER SUMMARIZATION AND CUSTOMIZED DICTIONARY

(71) Applicant: International Business Machines Corporation, Armonk, NY (US)

(72) Inventors: Victor A. Garibay, Leander, TX (US); Daniel E. Hurlimann, Austin, TX (US); Chetan Mehta, Austin, TX (US); Doorlabh Panjwani, Bangalore (IN)

(73) Assignee: International Business Machines Corporation, Armonk, NY (US)

(21) Appl. No.: 14/970,760

(22) Filed: Dec. 16, 2015

(51) Int. Cl. G06F 3/0483; G06F 17/28

(52) U.S. Cl. CPC G06F 3/0483; G06F 17/28

(57) ABSTRACT

Provided are techniques for capturing and displaying context information associated with a displayed document, comprising identifying a first plurality of words within a displayed document; applying natural language processing (NPL) to text in proximity to the first plurality of words in the document to identify a first context sensitive usage corresponding to the first plurality of words; storing a reference to the first plurality of words in conjunction with the first context sensitive usage; and in response to a user selection of the first plurality of words, displaying the first context sensitive usage in conjunction with the first plurality of words.

### FIELD OF DISCLOSURE

The claimed subject matter relates generally to e-readers, tablets and other electronic devices with a display for reading electronic material and, more specifically, to techniques for providing context sensitive notes and reference materials.

### BACKGROUND OF THE INVENTION

E-readers, tables and other electronic devices with a display for reading electronic material are becoming very popular. There are many such devices and third-party applications that provide this facility, For the sake of simplicity, all such devices and applications will be referred to as “e-readers,” Sonic current e-readers enable material to be read audibly to a user using text-to-speech technology with a variety of options such as options to control speed, voice and language translation of an audio signal. Other features include auditory highlighting to enable a reader to keep track of that which is being read.

Many e-readers enable a user to highlight selected portions of a text and perhaps add notes. in addition, many currently available e-readers include a dictionary or thesaurus with pre-defined, non-context sensitive usage examples.

### SUMMARY

Provided are techniques for framework to enhance a user's learning experience with respect to e-readers, tablets and any other electronic device with a display for reading electronic material by providing the ability to generate context sensitive notes and reference materials. A framework enables user to customize and selectively archive text from a source document and to store context information in conjunction with the archived text. In addition, the disclosed technology enables a user to generate customized dictionaries and thesauruses that provide context sensitive information and allow a user to store search words in conjunction with examples from the source document.

Provided are techniques for capturing and displaying context information associated with a displayed document, comprising identifying a first plurality of words within a displayed document; applying natural language processing (NPL) to text in proximity to the first plurality of words in the document to identify a first context sensitive usage corresponding to the first plurality of words; storing a reference to the first plurality of words in conjunction with the first context sensitive usage; and in response to a user selection of the first plurality of words, displaying the first context sensitive usage in conjunction with the first plurality of words.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is an E-reader Context Engine (ECE) architecture that may support the claimed subject matter.

FIG. 2 is a block diagram of an ECE, first introduced in FIG. 1, in greater detail.

FIG. 3 is a flow chart of a Context Generation process that may implement aspects of the claimed subject matter.

FIG. 4 is a flow chart of a Context Display process that may implement aspects of the claimed subject matter.

FIG. 5 is an illustration of a screen displaying section of text in accordance with the claimed subject matter.

FIG. 6 is an illustration of the screen of FIG. 5, displaying a second section of text in conjunction with information selected from the section of text in FIG. 5 in accordance with the claimed subject matter.

FIG. 7 is an illustration of the screen of FIGS. 5 and 6, displaying a context file generated in accordance with the claimed subject matter.

FIG. 8 is an illustration of the screen of FIGS. 5 and 6, displaying a Table of Content (TOC) merged with selected content in accordance with the claimed subject matter.

### DETAILED DESCRIPTION

The present invention may he a system, a method, and/or a computer program product at any possible technical detail level of integration. The computer program product may include a computer readable storage medium (or media) having computer readable program instructions thereon for causing a processor to carry out aspects of the present invention.

The computer readable storage medium can he a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing, A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-oral y memory (CD-ROM), a digital versatile, disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may he assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also he stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also he noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

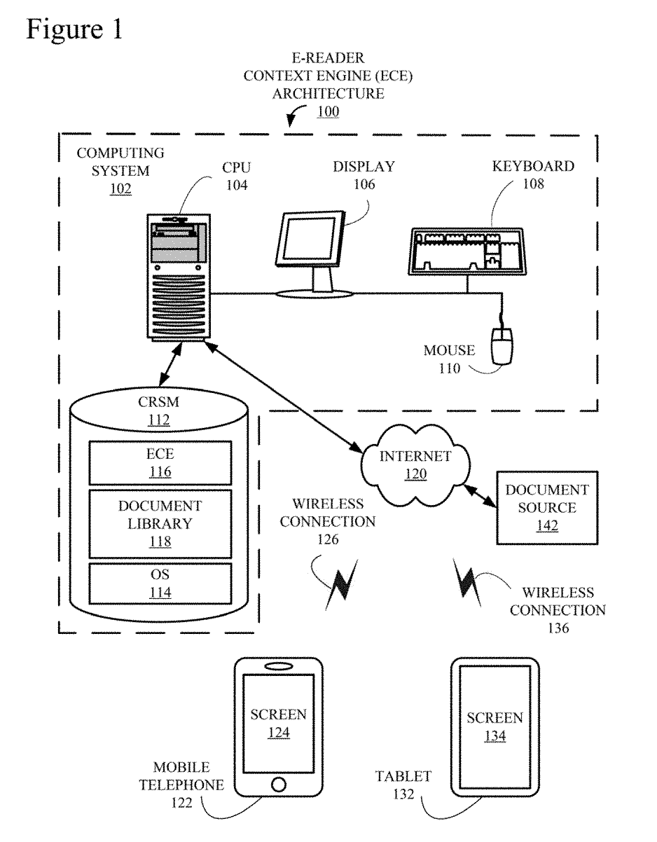

Turning now to the figures. FIG. 1 is an example an E-reader Context Engine (ECE) architecture 100 that may support the claimed subject matter. A computing system 102 includes a central processing unit (CPU) 104, coupled to a monitor 106, a keyboard 108 and a pointing device, or “mouse,” 110, which together facilitate human interaction with elements of architecture 100 and computing system 102. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing an operating system (OS) 114, an E-reader Context Engine 116 that incorporates aspects of the claimed subject matter and a document library 118. Components 116 and 118 represent components of a e-reader document system that enhance readers' e-reader experience.

Computing system 102 and CPU 104 are connected to the Internet 120, which is also assessable by a mobile telephone 122 and a tablet computer, or simply “tablet,” 132. Both mobile telephone 122 and tablet 132 include a display, or screen, i.e., a screen 124 and a screen 134, respectively. Mobile telephone 122 and tablet 132, as well as computing system 102, are used as examples of devices that may implement the claimed subject matter. Those with skill in the relevant arts should realize that there are many different types of devices than may benefit from the disclosed technology and that devices 102, 122 and 132 are simply three examples used for illustration in this Specification.

Mobile telephone 122 is coupled to the Internet 120 via a wireless connection 126 and table 142 via a wireless connection 136 Also coupled to the Internet 120 is a document source 142. Document source 142 represents any commercial or private source of documents, or “e-docs.” Those with skill in the relevant arts should realize that there are many potential sources for e-docs that may be employed in conjunction with the claimed subject matter.

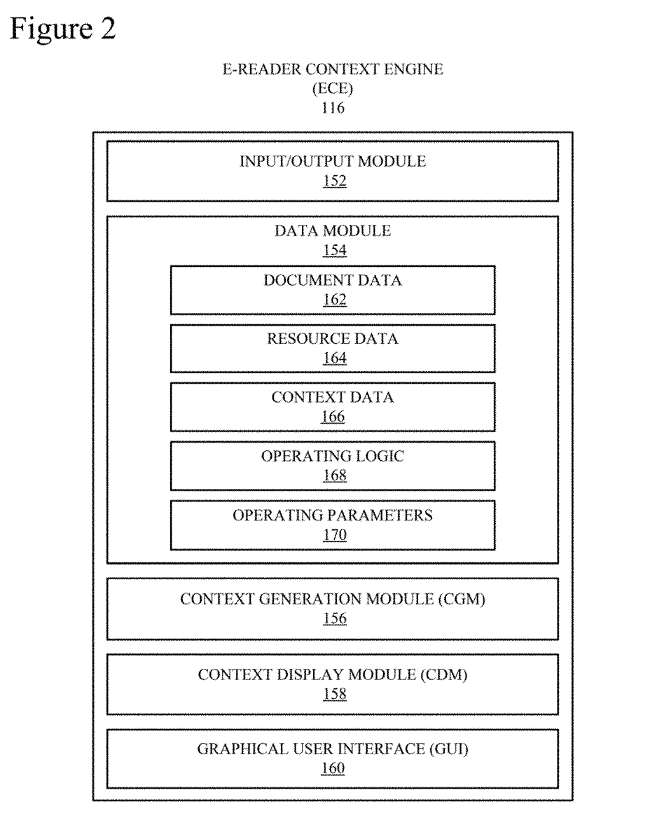

Although in this example, computing system 102 mobile telephone 122, tablet 132 and document source 142 are communicatively coupled via the Internet 120, they could also be coupled through any number of communication mediums such as, but not limited to, a local area network (LAN) (not shown), a plain old telephone system (POTS) (not shown) and hard wires (not Shown). Further, it should be noted there are many possible architecture configurations that may support the claimed subject matter, of which architecture 100 is only one simple example. The elements of FIG. 1 and their relationships are described in more detail below in conjunction with FIGS. 2-8.

FIG. 2 is a block diagram of ECE 116, first introduced in FIG. 1, in greater detail. ECE 116 includes an input/output (I/O) module 152, a data module 154, a context generation module (CGM) 156, a context display module (CDM) 158 and a graphical user interface (GUI) 160. For the sake of the following examples, logic associated with ECE 116 is assumed to be stored in CRSM 112 (FIG. 1) and executed on one or more processors (not shown) of CPU 104 (FIG. 1) of computing system 102 (FIG. 1). It should be understood that the claimed subject matter can be implemented in many types of computing systems and data storage structures such as those associated with mobile telephone 122 (FIG. 1) and table 132 (FIG. 1) but, for the sake of simplicity, is described only in terms of computing system 102 and architecture 100 (FIG. 1). Further, the representation of ECE 116 in FIG. 2 is a logical model. In other words, components 152, 154, 156, 158 and 160 may be stored in the same or separates files and loaded and/or executed within computing system 102 and architecture 100 either as a single system or as separate processes interacting via any available inter process communication (IPC) techniques.

I/O module 152 handles any communication ECE 116 has with other components of computing system 102 and architecture 100. Data module 154 is a data repository for information ECE 116 requires during normal operation. Examples of the types of information stored in data module 154 include document data 162, resources data 164, context data 166, operating logic 168 and operating parameters 170.

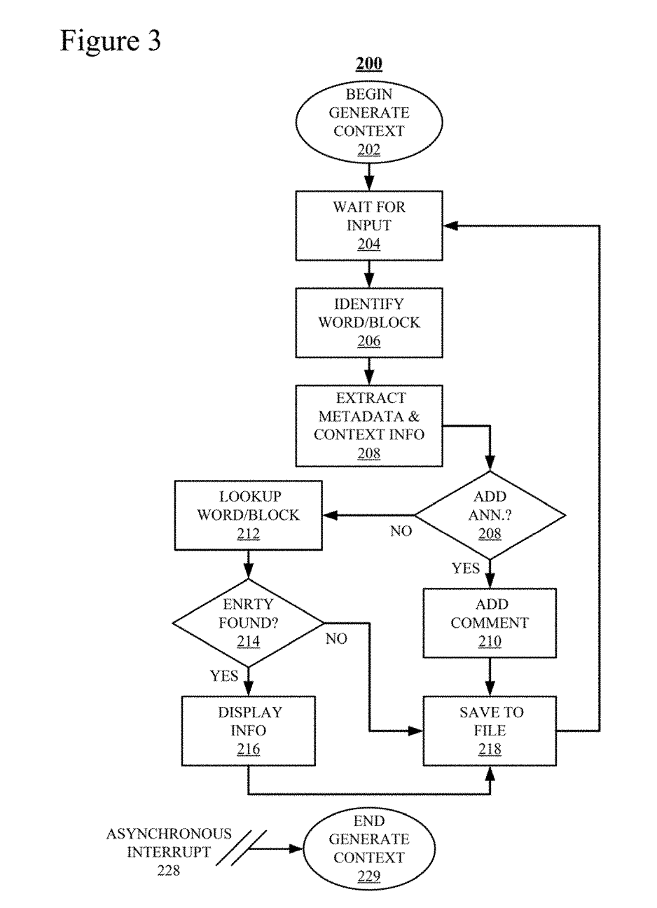

Document data 162 stores information on e-docs that have been or may be processed in accordance with the claimed subject matter. Such information may simply indicate where such documents may he located either within computing system 102 or an external document repository such as document source 142 (FIG. 1). In the alternative or in addition, document data 162 may store the actual e-docs. Resource data 164 stores information on various resources available to ECE 116. Such resources may include, but are not limited to, dictionaries and thesauruses, employed in conjunction with the claimed subject matter. Such resources may be stored within computing system 102 or remotely. Context data 166 stores information that a user of ECE 116 has generated in accordance with the claimed subject matter. Such information is described in more detail below in conjunction with FIGS. 3-8 and may include, but is not limited to, chapter information; section information; sub-section information; page information; and dictionary information.

Operating logic 168 stores computer instructions, or code, that executes with respect to 116. Operating parameters 170 stores variables and parameters that control the operation of ECE 116. Such variables anti parameters may be set by either users or administrators to control the look and feel of ECE 116 as well as set limits on specific operations.

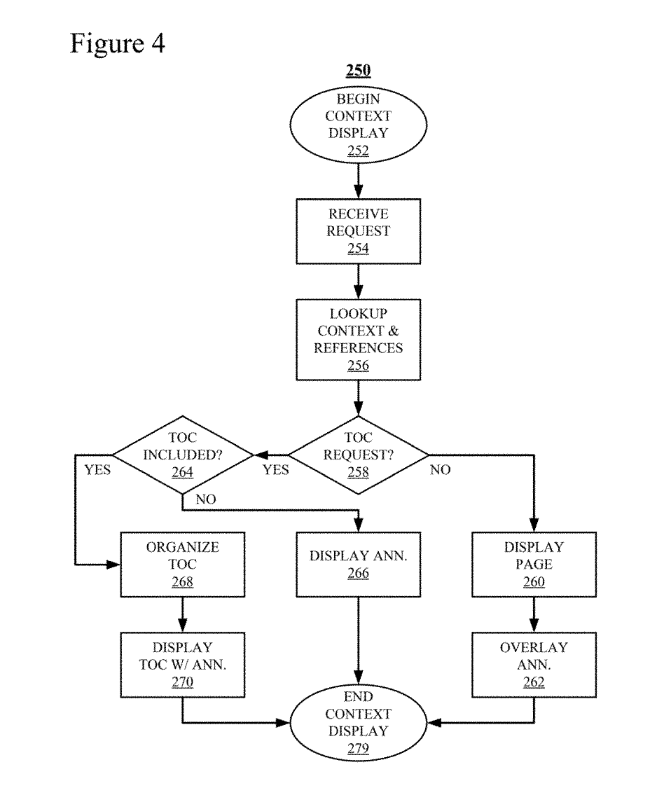

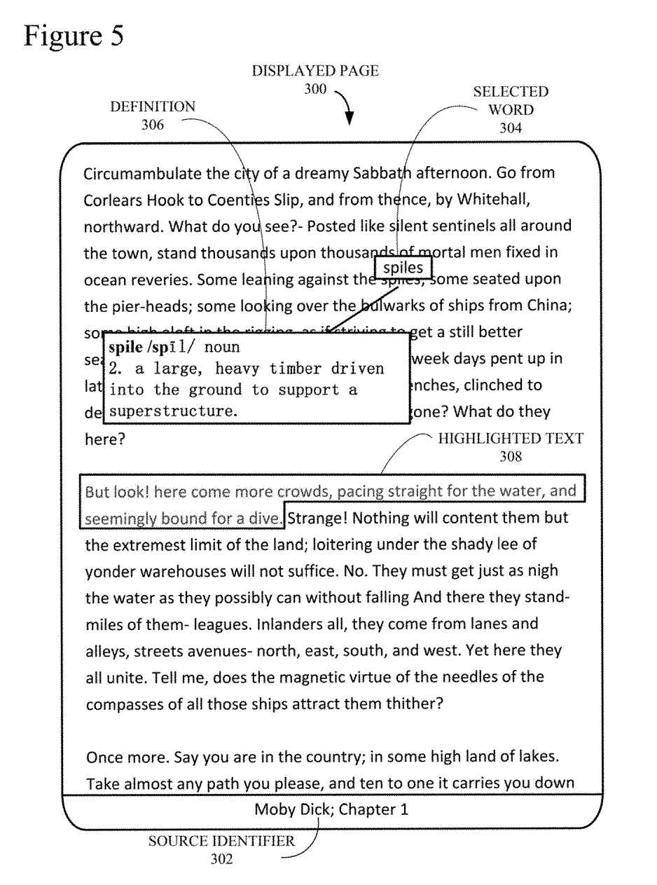

CGM 156 is responsible for the collection and storing of context information generated by a user (see 290, FIG. 3). CGM 156 may include a natural language processor (NLP) for generating context sensitive usage information. CDM 158 is responsible for the display of context information generated by a user in conjunction with CGM 156 (see 250, FIG. 4). CGM 156 and CDM 158 are described in more detail below in conjunction with FIGS. 3-6. GUI 160 enables users of ECE 116 to interact with and to define the desired functionality of ECE 116 as well as to display e-docs processed in accordance with the claimed subject matter. Aspects of GUI 160 are described in more detail below in conjunction with FIGS. 5-8.

FIG. 3 is a flow chart of a Context Generation process 200 that may implement aspects of the claimed subject matter. In this example, logic associated with process 200 is stored on CRSM 112 (FIG. 1) as part of ECE 116 (FIG. 1) and executed on one or more processors (not shown) of CPU 104 of computing system 102 (FIG. 1).

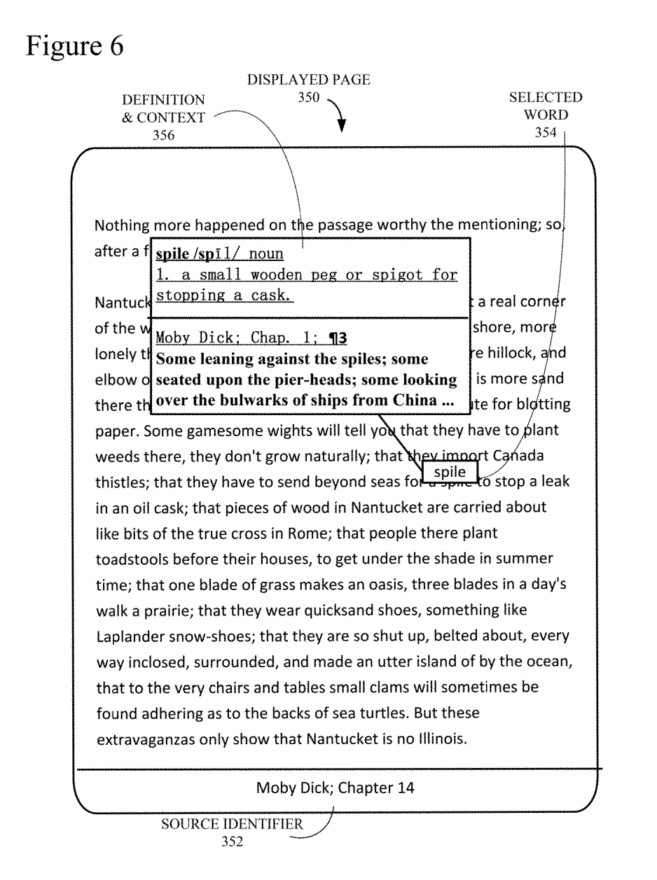

Process 290 starts in a “Begin. Generate Context” block 202 and proceeds immediately to a “Wait for Input” block 204. During block 204, process 200 waits for a user to request action with respect to a displayed document (see FIGS. 5 and 6). As explained in detail below in conjunction with FIGS. 4-8, such action may include, but is not limited to, a request to look up a word, highlight and/or comment on a selected portion of text. During processing associated with a “Identify Word/Block” block 206, a word to be looked up or a block of text that is highlighted and/or commented on is identified. A user's selection of a word or block of text in a document displayed on display 106 (FIG. 1) may be indicated by use of keyboard 108 (FIG. 13 and mouse 110 (FIG. 1) or, if a document is displayed on screen 124 (FIG. 1) or screen 134 (FIG. 1) by use of a finger or stylus on a touchscreen. It should be apparent to those with skill in the relevant arts that there are multiple ways, depending upon a particular platform, to indicate, or select, text in a displayed document.

During processing associated with an “Extract Metadata and Context Info” block 208, metadata associated with the word or block identified during processing associated with block 206 is extracted from the displayed document. Such information may include, but is not limited to, a chapter, sub-chapter, paragraph numbers, line numbers and references to similar words or text. In addition, context sensitive usage information may be generated (see 156, FIG. 2). During processing associated with a “Add Annotation (Ann.)?” block 208, a determination is made as to whether or not the user wishes to add a comment to the word or block identified during processing associated with block 206. lf so, control proceeds to an “Add. Comment” block 210, during which the user may add a comment or note to the identified word or block of words. If not, control proceeds to a “Lookup Word/Block” block 212. During processing associated with block 212, any previous references (see 166, FIG. 2) to the word or block are identified. In addition, context sensitive usage information may be employed to identify appropriate entries corresponding to the identified word or block of words. In one scenario, a single word may also generate a dictionary look up and a block of text a search for similar references within the document. For example, a phrase may be broken into keywords and a search of the document conducted for the keywords.

During processing associated with an “Entry Found?” block 214, a determination is made as to whether or not any relevant entries have been located. If so, the information located may be displayed on the user's screen (see 306, FIG. 5) during processing associated with a “Display Info” block 416. If not, the context information and the fact that the word or block was identified are saved to a context file such as context data 166 (FIG. 2) during processing associated with a “Save to File” block 218. Context and comments generated during processing associated with block 210 and context and information associated with identified entries generated during processing associated with block 212 are also saved to context data 166 during processing associated with block 218. Once data has been stored during processing associated with block 218, control returns to block 204, process 200 waits for additional input and processing continues as described above.

Finally, process 200 is halted by means of an asynchronous interrupt 228, which passes control to an “End Generate Context” block 229 in which process 200 is complete. Interrupt 228 is typically generated when computing system 192, OS 114 (FIG. 1) or ECE 116 of which process 200 is a part is itself halted. During normal operation of ECE 116, process 200 loops through the blocks 204, 206, 208, 210, 212, 214, 216 and 218, processing input as received.

FIG. 4 is a flow chart of a Context Display process 250 that may implement aspects of the claimed subject matter. Like process 200 (FIG. 3), in this example, logic associated with process 250 is stored on CRSM 112 (FIG. 1) as part of ECE 116 (FIG. 1) and executed on one or more processors (not shown) of CPU 104 of computing system 102 (FIG. 1).

Process 250 starts in a “Begin Context Display” block 202 and proceeds immediately to a “Receive Request” block 254. During block 254, process 250 receives a request to display it on an identified word or block of text (see 216, FIG. 3). In addition, a request may he generated by a user explicitly generating a query using GUI 160 (FIG. 2). During processing associated with a “Lookup Context and References” block 256, searches context data 166 (FIG. 2) for any references associated with the request received during processing associated with block 254. Such references may have been previously identified by a user or previous operation of the claimed subject matter or identified as part of the processing associated with block 256.

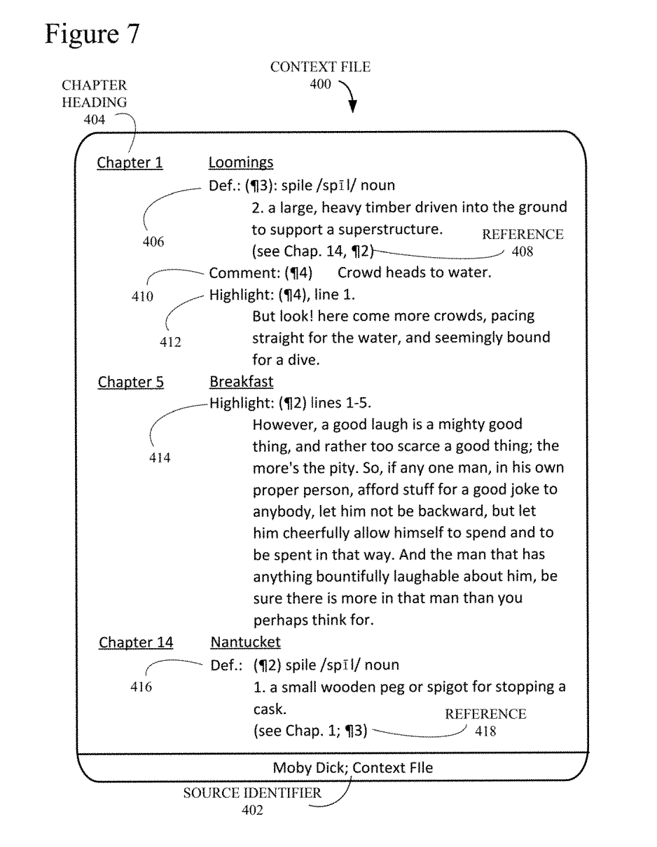

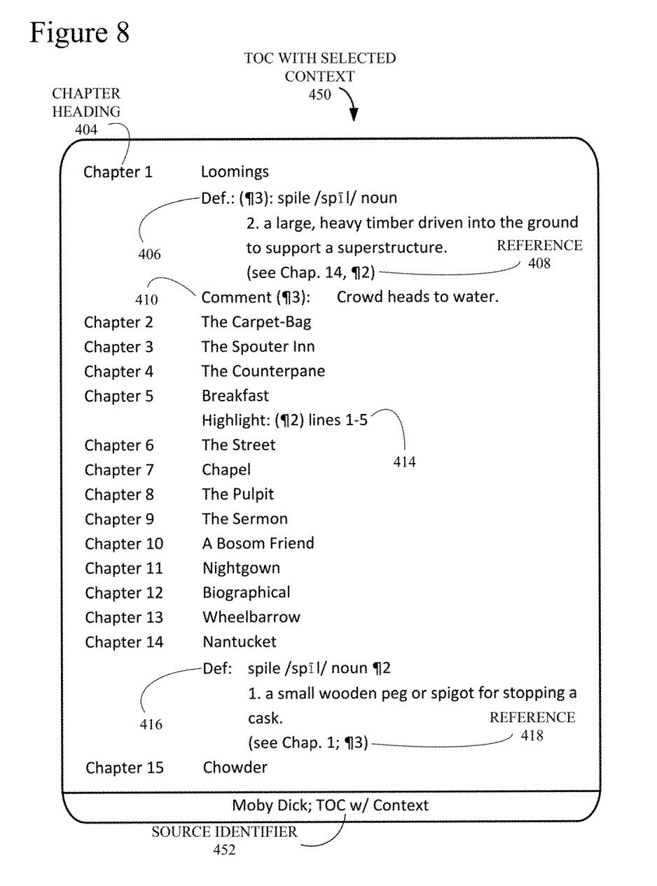

During processing associated with a “Table of Content (TOC) Request?” block 258, a determination is made as to the format of the requested display. As explained in more detail below, information may be displayed as an overlay on a displayed page of a document (see FIGS. 5 and 6), as standalone information, including, metadata and context information (see FIG. 7) or incorporated into a table of contents (see FIG. 8). It should he understood that these three examples are merely some alternatives of the manner in which the information may be displayed. GUI 160 may generate a user interlace that enables a user to control aspects of the generation, retrieval and display of content, context and context sensitive usage information, and wherein the aspects may be selected from a group consisting of number of separate context, summarization rules, ordering of display of separate context, and so on.

If a determination is made during processing, associated with block 258 that the request received during processing associated with block 254 is not a TOC request, processing proceeds to a “Display Page” block 260. During processing associated with block 260, the page in which the user has selected text is displayed. During processing associated with an “Overlay Annotations” (Ann)) block 262, the context and references identified during processing associated with block 256 are displayed as an over lay of the displayed page. Examples of this are illustrated in FIGS. 5 and 6.

If a determination is made during processing associated with block 258 that the request received during processing associated with block 254 is a TOC request, control proceeds to a “TOC Included?” block 264. During processing associated with block 264, a determination is made as to whether or not the documents TOC itself should be included. If not, control proceeds to a “Display Ann.” block 266 and the context information associated with the document is displayed in a summarized form. An example of such a display is illustrated in FIG. 7. If, during processing associated with block 264, a determination is made that the TOC should he included, control proceeds to an “Organize TOC” block 268. During processing associated with block 268, the context information retrieved and generated during processing associated with block 256 is incorporated with TOC information associated with the document. During processing associated with a “Display TOC” with (w/) Ann.) block 270, the TOC of the displayed document id display in conjunction with the context information. An example of this type of display is illustrated in FIG. 8.

Finally, once the page with annotation is displayed with the annotation as represented by blocks 260 and 262, the annotation alone is displayed in conjunction with block 266 or the annotations is displayed organized into the TOC in conjunction with block 270, control proceeds to an “End Context Display” block 279 in which process 250 is complete.

FIG. 5 is an illustration of a displayed page 300 with a section of text and annotations generated in accordance with the claimed subject matter. A source identifier 302 identifies the text as a portion of an e-book, which in the example is from Chapter 1 of the novel Moby Dick by Herman Melville. A user has selected a word 304, which in this example is the word “spile.” In accordance with the disclosed technology, a definition 306 of the word is displayed as an overlay on displayed page 300. Although there currently exists technologies to display the definitions of word in e-books, the disclosed technology has taken this technology further by applying NPL (see 156, FIG. 2) to determine context sensitive usage information associated with selected word 304. NPL processing has determined that the word “spile” in the surrounding context is a noun associated with a second definition of the word, i.e. “2. A large, heavy timber driven into the ground to support a superstructure.” This is in contrast to a first definition of the word as seen below in conjunction with 356 of FIG. 6, i.e. “1. a small wooden peg or spigot for stopping a cask.”

The user has also highlighted text 308 in displayed page 300. Actions associated with highlighted text 308, and selected word 304, may also include adding notes, or annotations, to be stored in conjunction with metadata such as chapter/sub-chapter, paragraph number and line numbers. In this manner, the claimed subject matter is able to generate associations among different portions of a text to aid the user in understanding, studying and displaying the text.

FIG. 6 is an illustration of a second displayed page 350 of the novel Moby Dick 300. A source identifier 352 identifies this portion as being from Chapter 14. As in FIG. 5 the user has identified a selected word 354, which is also the word “spile” but in a different context than the word 304 (FIG. 5). In this context, a definition and context 356 of the word “spile” is described as “a small wooden peg or spigot for stopping a cask.” In addition to a definition some additional information is provided, specifically that the word “spile” was also identified by the user in Chapter 1, ¶3 (see 304, FIG. 5). In addition, an excerpt from Chapter 1 is provided. Such information is stored in conjunction with document data 162 (FIG. 2) and context data 166 (FIG. 2), retrieved by CGM 156 (FIG. 2) and prepared for display by CDM 158 (FIG. 2).

FIG. 7 is an illustration of context data 400, generated in part by the user in conjunction with the displayed pages 300 (FIGS. 5) and 350 (FIG. 6). Source identifier 402 identifies the displayed page as information from a context file (see 166, FIG. 2) associated with the novel Moby Dick. In this example, only chapters in which a user has identified material are listed, Fro example, a chapter heading 404 identified Chapter 1. Although not labeled, Chapters 5 and 4 are also identified as having associated context information.

Information associate with Chapter 1 includes a definition (def.) 406 of the word “spile,” a reference 408 to another instance of the word, or “Chapter 14, ¶2,” a comment 410 that has been added by a user and a highlight 412 that indicates that the user has identified a block of text for future attention. In a similar fashion, a highlight 414 is identified in Chapter 5 and a definition 416 and reference 418 are identified in Chapter 14.

The particular elements displayed may be specified by the user with the use of GUI 160 (FIG. 2). For example, a user may specify that only definitions such as definitions 406 and 416 are displayed or that the location within the documents of highlights 412 and 414 are displayed but that the actual highlighted text is not.

FIG. 8 is an illustration of a TOC with selected context 450 displayed in accordance with the claimed subject matter. Like context data 400 of FIG. 7, displayed page 450 includes a source identifier 452. In this example and existing TOC of the novel Moby Dick is reproduced with additional information generated in accordance with the claimed subject matter. Such information includes definitions 406 and 416 and comment 410, all of which were first shown above in conjunction with FIG. 7. Also shown are chapter heading 404, references 408 and 418 and highlight 414. It should be noted that in this example, the user has specified that only a reference to highlighted portions such as highlights 412 be displayed without the corresponding text.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified to cal function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-7. (canceled)

8. An apparatus for capturing and displaying context information associated with a displayed document, comprising:
a processor;
a display;
a computer-readable storage medium coupled to the processor; and
computer code, stored on the computer-readable storage medium and executed on the processor, for performing a method, the method comprising:
identifying a first plurality of words within a document displayed on the display;
applying natural language processing (NPL) to text in proximity to the first plurality of words in the document to identify a first context sensitive usage corresponding to the first plurality of words;
storing, in the computer-readable storage medium, a reference to the first plurality of words in conjunction with the first context sensitive usage; and
in response to a user selection of the first plurality of words, displaying, on the display, the first context sensitive usage in conjunction with the first plurality of words.

9. The apparatus of claim 8, the method further comprising:
correlating the first context sensitive usage with a second plurality of words, wherein the second plurality of words are in a different location in the document than the first plurality of words; and
in response to a user selection of the second plurality of words, displaying the first context sensitive usage in conjunction with the first plurality of words.,

10. The apparatus of claim 8, wherein the first context sensitive usage includes information from a group, the group consisting of:
chapter information;
section information;
sub-section information;
page information; and
dictionary information.

11. The apparatus of claim 8, wherein the first context sensitive usage includes a second plurality of words that include the first plurality of words.

12. The apparatus of claim 8, wherein the first context sensitive usage includes a. summary of the first plurality of words based upon the NPL.

13. The apparatus of claim 8, the method farther comprising:
detecting the display of the first plurality of words;
associating the first plurality of words, with a second context sensitive usage stored in the data repository, and
displaying the second context sensitive usage in conjunction with the first plurality of words.

14. The apparatus of claim 8, further comprising a graphical user interface (GUI) that enables a user to control aspects of information stored in the data repository, wherein the aspects are selected from a group, the group consisting of:
a number of separate contexts;
summarization rules; and
ordering of display of the separate contexts.

15. A computer programming product for capturing and displaying context in associated with a displayed document, comprising a non-transitory computer-readable storage medium having program code embodied therewith, the program code executable by a plurality of processors to perform a method comprising:
identifying a first plurality of words within a document displayed on a display;
applying natural language processing (NPL) to text in proximity to the first plurality of words in the document to identify a first context sensitive usage corresponding to the first plurality of words;
storing, in the computer-readable storage medium, a reference to the first plurality of words in conjunction with the first context sensitive usage; and
in response to a user selection of the first plurality of words, displaying, on the display, the first context sensitive usage in conjunction with the first plurality of words.

16. The computer programming product of claim 15, the method further comprising:
correlating the first context sensitive usage with a second plurality of words, wherein the second plurality of words are in a different location in the document than the first plurality of words; and
in response to a user selection of the second plurality of words, displaying the first context sensitive usage in conjunction with the first plurality of words.

17. The computer programming product of claim 15, wherein the first context sensitive usage includes information from a group, the group consisting of:
chapter information;
section information;
sub section information;
page information; and
dictionary information.

18. The computer programming product of claim 15, wherein the first context sensitive usage includes a second plurality of words that include the first plurality of words.

19. The computer programming product of claim 15, the method further comprising:
detecting the display of the first plurality of words;
associating the first plurality of words, with a second context sensitive usage stored in the data repository; and
displaying the second context sensitive usage in conjunction with the first plurality of words.

20. The computer programming product of claim 15, further comprising a graphical user interface (GUI) that enables a user to control aspects of information stored in the data repository, wherein the aspects are selected from a group, the group consisting of:
a number or separate contexts;
summarization rules; and
ordering of display of the separate contexts.
